(19) United States
(12) Patent Application Publication
(10) Pub. No.: US 2004/0204963 A1
(43) Pub. Date: Oct. 14, 2004

(54) Healthcare payer organization and provider organization information exchange system

(76) Inventors: Kevin R. Klueh, Wayne, PA (US); Todd W. Fritsche, Phoenixville, PA (US)

Correspondence Address: Alexander J. Burke, Intellectual Property Department, 5th Floor, 170 Wood Avenue South, Iselin, NJ, 08830, US

(21) Appl. No.: 10/790,282

(22) Filed: Mar. 1, 2004

Related U.S. Application Data
(60) Provisional application No. 60/453,118, filed on Mar. 7, 2003.

(51) Int. Cl. G06F 17/60

(52) U.S. Cl. 705/2; 705/3; 705/35

(57) ABSTRACT

A system provides access by healthcare payer organization personnel to information maintained by a healthcare provider organization. An acquisition processor acquires and collates information from one or more healthcare provider organization information systems including: patient medical eligibility determination related information; patient admission, discharge, and transfer related information; and patient clinical information. An authentication processor verifies that a healthcare payer organization user is authorized to access the acquired collated patient information in response to user entered identification data. A user interface generator provides data representing a display image including elements of the acquired and collated information to an authorized user in response to user command.

### CROSS-REFERENCE TO RELATED APPLICATIONS

The present application is a non-provisional application of provisional application having serial No. 60/453,118 filed by Klueh, et al. on Mar. 7, 2003.

### FIELD OF THE INVENTION

The present invention generally relates to information systems and more particularly to a system and method for sharing healthcare information between a healthcare payer organization and a healthcare provider organization.

### BACKGROUND OF THE INVENTION

The healthcare industry represents one of the single largest expenditures in the United States and encompasses hospital, doctor, and pharmaceutical payments, as well as other health and medical related expenses.

The healthcare industry is primarily insurance-based, and service providers, such as hospitals, doctors, and pharmacies, ultimately rely on the credit of the insurers to satisfy most financial obligations. Two basic insurance systems include an indemnity system and a third party payment system. In the indemnity system, patients make payments to service providers and then claim and collect from the insurers. In a third party payment system, service providers deal directly with insurers or other obligors for primary payment, in addition to collecting optional co-payments directly from patients.

An obligor is an entity that is generally considered as ultimately responsible for making payment for the healthcare services provided on its behalf and for the insurance risk associated with a plan. Plan sponsors may also be obligors, as is the case with self-insured corporations. An obligor may also function as an administrator, as is the case with certain insurance carriers, or as a payer or adjudicator. Most of the obligors utilize separate entities that perform these functions to facilitate their programs.

An administrator, often called a third-party administrator (“TPA”), designs, structures and services insurance plans on behalf of another. A plan is a set of parameters that indicates the eligibility and types of insurance coverage of a particular group of insured persons. TPAs also maintain service provider networks, and enroll and contract with healthcare providers on behalf of obligors. Some TPAs also provide payment services for obligors. They bill the obligor for approved claims on a regular basis and remit payments to the service provider on behalf of the plan sponsor. TPAs may subcontract certain functions to payers and adjudicators.

A payer is an entity, usually a TPA or obligor, that issues payments to service providers on behalf of obligors. A payer also provides obligors with management reports and sends service providers, along with payment, a remittance advice (i.e., a report outlining which transactions have been handled and positively adjudicated in the indicated processing cycle, along with any adjustments and processing charges) together with the payment. The total indicated on a remittance advice should equal the amount of the payment that it accompanies.

An adjudicator is an entity that provides on-line and/or paper-based manual adjudication services. An adjudicator's responsibility is to adjudicate claims by applying the plan parameters established by the TPA (i.e., determining the acceptability of a claim based, for example, on a claimant's eligibility, the medication, and price), and then to report the results to the TPA or plan sponsor on a scheduled basis. Each payer selects a standard reimbursement payment cycle, typically fourteen or thirty days, during which the adjudicator adjudicates claims submitted over the on-line network by service providers. At the end of each processing cycle, adjudicators “rule-off” the accumulated claims and report the results. They then forward their “experience” tapes for the relevant period, which itemize all of the approved transactions, to each TPA or plan sponsor who reviews the tapes and then makes payments to the service providers.

The following example serves to illustrate the complex set of relationships between plan sponsors, obligors, TPAs, payers, and adjudicators. A corporation, acting as plan sponsor, decides to provide insurance coverage to its employees and arranges for an insurance company to provide that coverage. The insurance company, acting as obligor, administrator, payer, and adjudicator, collects premiums (coverage payments) from the corporation, underwrites the actuarial risk associated with the plan, administers the corporation's plan, makes payments to the service providers and adjudicates the insurance claims. After several years, the same corporation does an actuarial and economic analysis and finds that it would be less costly to underwrite the insurance risk associated with the plan itself. The corporation, now acting as a self-insured obligor, permits the agreement with the insurance company to expire, and arranges with a TPA directly to administer its employee insurance coverage. For similar reasons, several other employers decide to take the same course of action and become self-insured. The insurance company, concerned with the loss of business, decides to reduce costs and premiums by contracting out some of its administrative functions. It therefore arranges with a TPA to handle its payer and adjudicator functions.

Present systems and processes for collecting necessary patient data for utilization (e.g., payment) and/or case management review by a payer's staff are both disruptive and manual resulting in a considerable expense to payers and providers. Present systems and processes create an enormous administrative burden and cost associated with a manual process of performing utilization and/or case management review, currently facilitated by phone, fax, or through the expense of onsite payer case/utilization management personnel. Improvements needed to overcome the problems created by the present manual process include:

reducing the need for onsite case managers by permitting case managers to access patient information anytime and anywhere;

reducing the amount of time that the providers care givers or case managers spend on the phone communicating the clinical data needed by payer case managers (i.e., administrative work) to permit the care givers to focus more time and effort on caring for patients and improving clinical outcomes;

eliminating the need, in many instances, to fax confidential patient information that can be inadvertently transmitted to the wrong party, and eliminating the time needed to send the fax;

diminishing the time and cost required to duplicate, package and transmit patient records for payer review;

streamlining the approval process for authorizing additional inpatient days and reduce denial of claims for the same;

improving payer/provider relations and communications; and

reducing payer/provider resource expenditures for utilization and case management.

Accordingly, there is a need for a system and method for sharing healthcare information between a healthcare payer organization and a healthcare provider organization that overcomes these and other disadvantages of the prior systems and processes.

### SUMMARY OF THE INVENTION

According to one aspect of the present invention, a system provides access by healthcare payer organization personnel to information maintained by a healthcare provider organization. An acquisition processor acquires and collates information from one or more healthcare provider organization information systems including: patient medical eligibility determination related information; patient admission, discharge, and transfer related information; and patient clinical information. An authentication processor verifies that a healthcare payer organization user is authorized to access the acquired collated patient information in response to user entered identification data. A user interface generator provides data representing a display image including elements of the acquired and collated information to an authorized user in response to user command.

### BRIEF DESCRIPTION OF THE DRAWINGS

FIG. 1 illustrates an information exchange system, in accordance with a preferred embodiment of the present invention.

FIG. 2 illustrates a method for the information exchange system, as shown in FIG. 1, in accordance with a preferred embodiment of the present invention.

FIG. 3 illustrates a user interface for integrated care management of multiple patients in the information exchange system, as shown in FIG. 1, in accordance with a preferred embodiment of the present invention.

FIG. 4 illustrates a user interface for integrated care management of a particular patient in the information exchange system, as shown in FIG. 1, in accordance with a preferred embodiment of the present invention.

FIG. 5 illustrates a user interface for integrated care management of clinical data for a particular patient in the information exchange system, as shown in FIG. 1, in accordance with a preferred embodiment of the present invention.

### DETAILED DESCRIPTION OF THE PREFERRED EMBODIMENTS

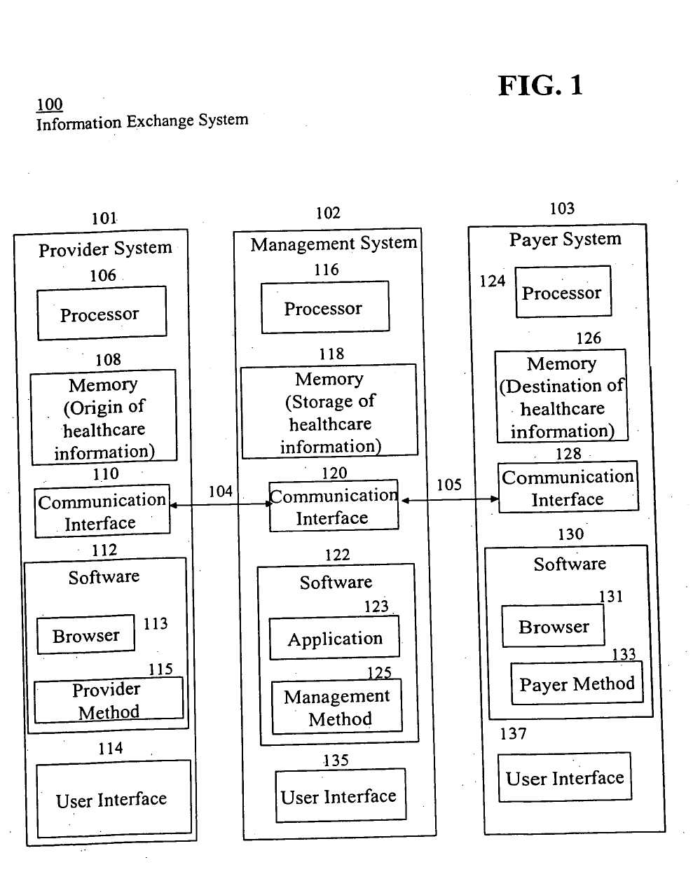

FIG. 1 illustrates an information exchange system (herein called the “system”) 100, in accordance with a preferred embodiment of the present invention. The system 100 generally includes a healthcare provider system 101 (herein called a “provider system”), a management system 102, a payer system 103, a first communication network 104, and a second communication network 105. The system 100 generally permits the provider system 101 and the payer system 103 to exchange, share, transfer, send, relay, provide, etc. healthcare information using the management system via the first communication network 104 and the second communication network 105.

The system 100 provides authorized, secure, real-time, self-service access to patient (e.g., inpatient) healthcare information for review by utilization (e.g., payment) staff and/or case management staff of both the providers and the payers. The system 100 solves an enormous administrative burden and cost associated with a manual process of performing utilization and/or case management review presently facilitated by phone, fax, or through the expense of onsite payer case/utilization management personnel.

The provider system 101 is intended for use by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client.

The system 100 generally provides an integrated care management (ICM) system to permit one or more healthcare providers to share healthcare information about their patients with one or more payers. The ICM system is preferably represented as a web-based application implemented on a browser for access by the healthcare provider and the payer. Patient case management staff may also use system 100.

Preferably, a third party administers the management system 102, which is different from the provider system 101 and the payer system 103. Third party administration permits multiple provider systems 101 and multiple payer systems 103 to access healthcare information stored and managed by a common system, while permitting the multiple provider systems 101 and multiple payer systems 103 to maintain privacy and security, as required or desired. Although the third party administers the management system 102, the healthcare information stored in the management system 102 is up to date because the provider system 101 substantially immediately and in real time uploads any changes in the provider's healthcare information to the management system 102. The third party may be a separate business entity unrelated to either the business entities running the provider systems 101 and multiple payer systems 103. Alternatively, the third party may be a separate business entity related (e.g., a subsidiary) to one the business entities running the provider systems 101 and multiple payer systems 103.

The provider system 101 includes a processor 106, a memory 108, a communication interface 110, software 112, and a user interface 114. The software 112 further includes a browser 113 and a provider method 115. The provider system 101 is preferably implemented as a workstation, server, or other network-based system, but may be implemented as a personal computer. The provider system 101 may be fixed or mobile, and may be implemented in a variety of forms including, without limitation, a desktop computer, a laptop computer, a personal digital assistant (PDA), and a cellular telephone. Each of the referenced elements, as well as other known elements not shown, in the provider system 101 are interconnected in a manner well known to those skilled in the art of provider systems.

Preferably, the user interface 114 in the provider system 101 generally includes an input device (not shown) that permits a user to input information into the client 101 and an output device (not shown) that permits a user to receive information from the provider system 101. Preferably, the input device is a keyboard, but also may be a touch screen, or a microphone with a voice recognition program, for example. Preferably, the output device is a display, but also may be a speaker, for example. The output device provides information to the user responsive to the input device receiving information from a user or responsive to other activity by the provider system 101. For example, a display presents information responsive to a user entering information in the provider system 101 via a keyboard.

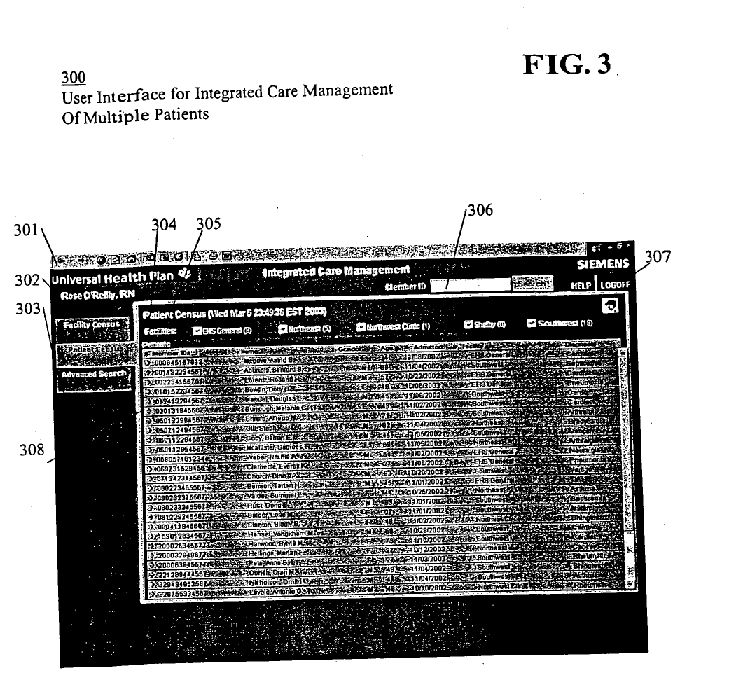

Preferably, browser software 113 cooperates with the user interface 114 by permitting information to be entered into the browser software 113 and by permitting information to be displayed by the browser software 113. Each of the management system 102 and the payer system 103 may also have a user interface 135 and 137, respectively, having an input device and an output device, which operates in the same or different way than the user interface 114 of the provider system 101. Preferably, the user interface 135 includes a user interface generator that providing data representing a display image, as shown in FIGS. 3, 4, and 5, including the healthcare information to an authorized user in response to a user command from the provider system 101 or the payer system 103.

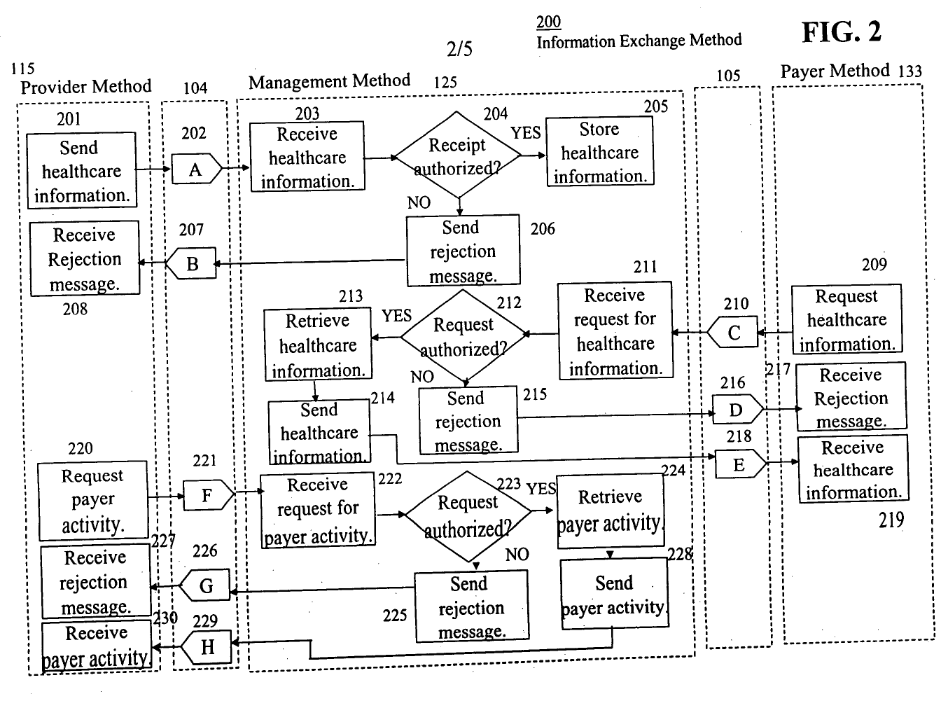

The processor 106, the memory 108, and the communication interface 110 are each well known to those skilled in the art of provider systems. The memory 108 stores the software 112, including the browser software 113 and the provider method 115. The provider method 115 is described in further detail in FIG. 2. The communication interface 110 is adapted to send and/or receive wired or wireless communications over the first communication path 104.

The memory 108 also stores healthcare information related to the people being serviced by the healthcare provider. The healthcare information generally includes case management information and/or claim processing information related to a patient's healthcare. For example, the healthcare information may include, without limitation and either alone or in combination: patient census information, clinical reports, images, documents and data associated with a patient record, patient record scanned documents, detailed information about a particular patient, patient medical eligibility determination related information, patient admission, discharge, and transfer related information, patient clinical information, patient demographic information, patient financial information, and patient accounting and billing information.

Preferably, the healthcare information is generated, originated, or sourced by one or more various healthcare sources within the provider system 101. Examples of the healthcare sources include, without limitation, a hospital system, a medical system, and a physician system, a records system, a radiology system, an accounting system, a billing system, and any other system required or desired in a provider system 101. The hospital system further includes, without limitation, a lab system, a pharmacy system, a financial system, and a nursing system. The medical system, otherwise called an enterprise, represents a healthcare clinic or another hospital system. The physician system represents a physician's office.

Typically, the systems in the hospital system are physically located within the same facility or on the same geographic campus. However, the medical system and the physician system are each typically located in a different facility at a different geographic location. Hence, the healthcare sources represent multiple, different healthcare sources that may have various physical and geographic locations within the provider system 101.

The one or more management systems 102 further include a processor 116, a memory 118, a communication interface 120, software 122, and a user interface 135. The processor 116 may otherwise be called and include an acquisition processor and an authentication processor. The management system 102 connects one or more provider systems 101 to one or more payer systems 103 via the first communication network 104 and via the second communication network 105. Preferably, the management system 102 is implemented as a personal computer, a workstation, a server, or other network-based system. The management system 102 may be fixed or mobile, and may be implemented in a variety of forms including, without limitation, a desktop computer, a laptop computer, a personal digital assistant (PDA), and a cellular telephone.

The user interface 135, in combination with browser software (not shown) if desired, may also be used with the management system 102, as described with the provider system 101, if required or desired. The software 122 further includes software applications 123 and a management method 125. Each of the referenced elements, as well as other known elements not shown, in the management system 102 are interconnected in a manner well known to those skilled in the art of management systems.

The processor 116, the memory 118, and the communication interface 120 are each well known to those skilled in the art of management systems. The memory 118 stores the software 122 and healthcare information received from the provider system 101. The software 122 includes the software applications 123 and the management method 125. The management method 125 is described in further detail in FIG. 2. The communication interface 120 is adapted to send and/or receive wired or wireless communications over the first communication path 104 and over the second communication path 105.

The payer system 103 further includes a processor 124, a memory 126, a communication interface 128, software 130, and a user interface 137. Preferably, the payer system 103 is implemented as a personal computer, a workstation, a server, or other network-based system. The payer system 103 may be fixed or mobile, and may be implemented in a variety of forms including, without limitation, a desktop computer, a laptop computer, a personal digital assistant (PDA), and a cellular telephone.

The software 130 further includes browser software 131 and a payer method 133. The payer method 133 is described in more detail in FIG. 2. Preferably, the user interface 137 with browser software 131 is used in the payer system 103, as shown in FIGS. 3, 4, and 5. Each of the referenced elements, as well as other known elements not shown, in the server(s) 103 are interconnected in a manner well known to those skilled in the art of servers.

The processor 124, the memory 126, and the communication interface 128 are each well known to those skilled in the art of servers. The memory 126 stores the software 130 and healthcare information retrieved from the management system 102. The software 130 includes the browser software 131 and the payer method 133. The browser software 131 and the payer method 133 are described in further detail in FIG. 2. The communication interface 128 is adapted to send and/or receive wired or wireless communications over the second communication path 105.

The first communication path 104 provides communications between the client 101 and the switch 102. The second communication path 105 provides communications between the switch 102 and the server(s) 103. The term “path” may otherwise be called a network, a link, a channel, or a connection. The first communication path 104 and the second communication path 105 may be the same path or different paths, depending on the particular system.

The communication path 104 may be formed as a wired or wireless (W/WL) connection. A wireless connection advantageously permits the provider system 101 to be mobile beyond the distance permitted by the wired connection. Preferably, the communication path 104 is formed as a wired connection. In the case of a wired connection, the IP address is preferably assigned to a physical location of the termination point of the wire. In the case of a wireless connection, the IP address is preferably assigned to the provider system 101, since the provider system 101 would be mobile. The communication path 105 also may be formed as a wired or wireless (W/WL) connection.

Each of the paths 104 and 105 may be formed as any type of network including, without limitation, a Local Area Network (LAN), such as an Intranet, for example, and a Wide Area Network (WAN), such as an Internet, for example. Preferably, the first communication path 104 is formed as the WAN, such as the Internet, and the second communication path 105 is formed as a LAN, such as the Intranet.

The Internet is a decentralized network of computers that communicate with one another via the TCP/IP. The explosive growth in use of the Internet is due in part to the development in the early 1990's of the worldwide web (WWW), which is one of several services provided on the Internet. Other services include, without limitation, communication services such as Email, file transfer protocol (FTP), telnet, newsgroups, internet relay chat (IRC), instant messaging, information search services such as Google™ and AltaVista™, and information retrieval services such as file transfer protocol (FTP).

In the preferred embodiment of the present invention, the provider system 101 or the management system 102 may be considered a server, and the payer system 103 may be considered a client. The web browser, such as Explorer™ (MicroSoft Corp.) or Navigator™ (Netscape Communication Corp.), send a request over the WWW to a server requesting a web page identified by a uniform resource locator (URL), which notes both the server where the web page resides and the file or files on that server which make up the web page. The server sends a copy of the requested file(s) to the web browser, which in turn displays the web page to the user. The web pages on the WWW may be hyper-media documents written in a standardized language called Hyper Text Markup Language (HTML). A typical web page includes text together with embedded formatting commands, referred to as tags, which can be used to control font size, font style and the like.

Each of the communication paths 104 and 105 may use any type of protocol, otherwise called data format, including, without limitation, an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, an Institute Of Electrical And Electronic Engineers (IEEE) bus compatible protocol, and an Health Level Seven (HL7) protocol.

Each of the paths 104 and 105 may use any type of address scheme including, without limitation, an address corresponding to a type of protocol described above, and a Universal Resource Locator (URL), otherwise called a web page address.

Each of the paths 104 and 105 may communicate any type of data for any type of application including, without limitation, still pictures, streaming video, audio, telephone messages, computer programs, messages, instructions, and Emails.

FIG. 2 illustrates an information exchange method 200 (otherwise called the “method”) for the information exchange system, as shown in FIG. 1, in accordance with a preferred embodiment of the present invention. The method 200 generally includes the provider method 115, the management method 125, the payer method 133, the first communication network 104, and the second communication network 105.

The information exchange method 200 generally provides an integrated care management (ICM) method to permit one or more healthcare providers to share healthcare information about their patients with one or more payers. The ICM method is preferably represented as a web-based application implemented on a browser for access by the healthcare provider and the payer.

The provider method 115 further includes steps 201, 208, 220, 227 and 230. The management method 125 further includes steps 203, 204, 205, 206, 211, 212, 213, 214, 215, 222, 223, 224, 225, and 228. The payer method 133 further includes steps 209, 217 and 219. The first communication path 104 further includes communications 202, 207, 21, 226, and 229. The second communication path 105 further includes communications 210, 216, and 218.

The first group of consecutively numbered steps and communications includes steps and communications 201-208 and generally relates to the provider system 101 sending healthcare information to the management system 102 for storage in the memory 118 in the management system 102.

At step 201, the method 200 starts by the provider method 115 sending healthcare information to the management system 102. The provider method 115 may send any healthcare information, at any time, at any frequency of time, and either automatically or responsive to a manual command. The term “sending” may otherwise be called transmitting, uploading, relaying, and storing.

At communication 202, the first communication path 104 sends the healthcare information from the provider system 101 to the management system 102 responsive to step 201.

At step 203, the management method 125 receives (i.e., acquires) the healthcare information from one or more provider systems 101 via the first communication path 104 responsive to communication 202. For example, the management method 125 may receive the healthcare information from one or more of multiple different locations, multiple different healthcare provider organizations, and multiple different computerized information systems.

At step 204, the management method 125 determines (i.e., verifies) whether the provider system 101 is authorized to send the healthcare information to the management system 102. This authorization feature permits authorized healthcare providers to send information to the management system 102. Since the healthcare information may be used for such purposes as managing a patient's case and facilitating payment of a patient's care, it is desirable that the healthcare information be sent from a reliable and trusted source. The authorization feature may be implemented in a variety of ways, including, without limitation, and alone or in combination, passwords, and encoded information. If the management method 125 determines that the receipt of the healthcare information is authorized, then the management method 125 continues to step 205. If the management method 125 determines that the receipt of the healthcare information is not authorized, then the management method 125 continues to step 206.

At step 205, the management method 125 stores the healthcare information in the memory 118 responsive to a positive determination by the management method 125 at step 204. The healthcare information may be stored in any format (e.g., collated) and in any combination, which may be determined by one or more of the provider system 101, the management system 102, and the payer system 103. FIGS. 3, 4, and 5 illustrate examples of the content and the format of the healthcare information that is stored in the memory 118.

At step 206, the management method 125 sends a rejection message to the provider system 101 responsive to a negative determination by the management method 125 at step 204. The rejection message may be of any type including, without limitation and in any combination, alpha, numeric, alphanumeric, human readable, and machine readable.

At communication 207, the first communication path 104 sends the rejection message from the management system 102 to the provider system 101 responsive to step 206.

At step 208, the provider system 101 receives the rejection message from the management system 102 responsive to the communication 207. The provider system 101 may respond to the rejection message in a variety of ways including, without limitation and in any combination, reporting the rejection, logging the rejection, resending the healthcare information, and changing the authorization.

The second group of consecutively numbered steps and communications includes steps and communications 209-219 and generally relates to the payer system 103 requesting healthcare information from the management system 102.

At step 209, the payer method 133 requests healthcare information from the management system 102. The payer method 133 may request any healthcare information, in any format, in any combination, at any time, at any frequency of time, and either automatically or responsive to a manual command. The term “request” may otherwise be called receiving, downloading, relaying, and storing.

At communication 210, the second communication path 105 sends the request for the healthcare information from the payer system 103 to the management system 102 responsive to step 209.

At step 211, the management method 125 receives and stores the request for the healthcare information from the payer system 103 via the second communication path 105 responsive to communication 210.

At step 212, the management method 125 determines whether the payer system 103 is authorized to request the healthcare information from the management system 102. This authorization feature permits authorized payers to request information from the management system 102. Since the healthcare information may be used for such purposes as managing a patient's case and facilitating payment of a patient's care, it is desirable that the healthcare information be requested from a reliable and trusted source. The authorization feature may be implemented in a variety of ways, including, without limitation, and alone or in combination, passwords, and encoded information. If the management method 125 determines that the request for the healthcare information is authorized, then the management method 125 continues to step 213. If the management method 125 determines that the request for the healthcare information is not authorized, then the management method 125 continues to step 215.

At step 213, the management method 125 retrieves the healthcare information from the memory 118 responsive to a positive determination by the management method 125 at step 212. The healthcare information may be retrieved in any format and in any combination, which may be determined by one or more of the provider system 101, the management system 102, and the payer system 103.

At step 214, the management method 125 sends the healthcare information from the management system 102 to the payer system 103 responsive to step 213. The healthcare information may be sent in any format that may be required or desired.

At step 215, the management method 125 sends a rejection message to the payer system 103 responsive to a negative determination by the management method 125 at step 212. The rejection message may be of any type including, without limitation and in any combination, alpha, numeric, alphanumeric, human readable, and machine readable.

At communication 216, the second communication path 105 sends the rejection message from the management system 102 to the payer system 103 responsive to step 215.

At step 217, the payer system 103 receives the rejection message from the management system 102 responsive to the communication 216. The payer system 103 may respond to the rejection message in a variety of ways including, without limitation and in any combination, reporting the rejection, logging the rejection, re-requesting the healthcare information, and changing the authorization.

At communication 218, the second communication path 105 sends the healthcare information from the management system 102 to the payer system 103 responsive to step 214.

At step 219, the payer system 103 receives the healthcare information sent from the management system 102 responsive to the communication 218. The payer system 103 may have one or more privileges related to the received healthcare information including, without limitation and in any combination, read only, read and write, printing, and storing. The privileges may be the same or different for different payer systems or different users in each payer system. FIGS. 3, 4, and 5 illustrate examples of the content and the format of the healthcare information that the payer system 102 receives.

Preferably, the management system 102 stores payer activity including, without limitation, the requests received at step 211, the healthcare information at step 214, and the rejection messages sent at step 215, or a summary of each of the same, for later retrieval and review by the provider system 101, if required or desired.

The third group of consecutively numbered steps and communications includes steps and communications 220-230 and generally relates to the provider system 102 requesting payer activity from the management system 102.

At step 220, the provider method 115 requests payer activity from the management system 102. Payer activity generally includes, without limitation and in any combination, any information about requests from the payer system 103, any information about healthcare information received by the payer system 103, and any information about requests for healthcare information that were rejected. The provider method 115 may send any payer activity, at any time, at any frequency of time, and either automatically or responsive to a manual command. The term “request” may otherwise be called receiving, downloading, relaying, and storing.

At communication 221, the first communication path 104 sends the request for payer activity from the provider system 101 to the management system 102 responsive to step 220.

At step 222, the management method 125 receives the request for payer activity from the provider system 101 via the first communication path 104.

At step 223, the management method 125 determines whether the provider system 101 is authorized to request the payer activity from the management system 102. This authorization feature permits authorized healthcare providers to request payer activity form the management system 102. Since the payer activity may be used for such purposes as managing a patient's case and facilitating payment of a patient's care, it is desirable that the request for payer activity be sent from a reliable and trusted source. The authorization feature may be implemented in a variety of ways, including, without limitation, and alone or in combination, passwords, and encoded information. If the management method 125 determines that the request for payer activity is authorized, then the management method 125 continues to step 224. If the management method 125 determines that the request for payer activity is not authorized, then the management method 125 continues to step 225.

At step 224, the management method 125 retrieves the payer activity from the memory 118 responsive to a positive determination by the management method 125 at step 223. The payer activity may be stored in any format and in any combination, which may be determined by one or more of the provider system 101, the management system 102, and the payer system 103.

At step 225, the management method 125 sends a rejection message to the provider system 101 responsive to a negative determination by the management method 125 at step 223. The rejection message may be of any type including, without limitation and in any combination, alpha, numeric, alphanumeric, human readable, and machine readable.

At communication 226, the first communication path 104 sends the rejection message from the management system 102 to the provider system 101 responsive to step 225.

At step 227, the provider system 101 receives the rejection message from the management system 102 responsive to the communication 226. The provider system 101 may respond to the rejection message in a variety of ways including, without limitation and in any combination, reporting the rejection, logging the rejection, resending the payer activity, and changing the authorization.

At step 228, the management system 102 sends the payer activity responsive to step 224. The payer activity may be sent in any format that may be required or desired.

At communication 229, the first communication path 104 sends the payer activity from the management system 102 to the provider system 101 responsive to the step 228.

At step 230, the provider system 101 receives the payer activity responsive to the communication 229. The provider system 101 may have one or more privileges related to the received payer activity including, without limitation and in any combination, read only, read and write, printing, and storing. The privileges may be the same or different for different provider systems or different users in each provider system.

In FIG. 2, the first, second, and third groups of consecutively numbered steps and communications generally represent independent communications between the provider system (101) and the management system (102) or between the payer system (103) and the management system (102). In other words, each of the provider system (101) communicates with the management system (102) by uploading the healthcare information, the payer system (103) communicates with the management system (102) to access the healthcare information, and the provider system (101) communicates with the management system (102) to access the payer activity. Although not shown in FIG. 2, the management system (102) may also facilitate dependent communications between the provider system (101) and the payer system (103). The dependent communications may include for example and without limitation: messages (e.g., letters, email messages, instant messages, posted messaged on healthcare documents), replies, documents, and reports, and may be in any form including, without limitation, alpha, numeric, alphanumeric, audible, and visual. The dependent communications via the management system 102 speeds up case healthcare management between the provider system 101 and the payer system 103 because questions or issues related to the healthcare management are communicated via the management system 102 (i.e., the same forum) where the healthcare information resides, rather than via a separate system.

FIG. 3 illustrates a user interface 300 for integrated care management of multiple patients in the information exchange system 100, as shown in FIG. 1, in accordance with a preferred embodiment of the present invention. The user interface 300 provides a web-based interface, otherwise be called an Integrated Care Management (ICM) portal. The user interface 300 permits a case manager for a payer to view their workload and review the pertinent demographic and clinical information about their inpatient population. The user interface 300 generally allows a case manager to sort by site or on any of the columns listed.

In particular, the user interface 300 includes browser tool bar 301 having browser menu icons, a user identification 302, a search menu 303, a search menu title 304, a facility menu 305, a member identification log on box 306, help and logoff items 307, and patient census information 308. The user interface 300 provides an example of the content and format of the healthcare information presented in the integrated care management (ICM) application. Other content and/or formats may be used, as required or desired.

The browser tool bar 301 is used to navigate among and within particular web applications, such as the preferred ICM application, shown in FIG. 3.

The user identification 302 identifies the particular user (e.g., “Rose O'Reilly, RN) of the ICM application. The user identification 302 may also identify, without limitation, a particular provider, payer, and department.

The search menu 303 provides various menu options permitting a user to search the healthcare information in various ways, such as, for example, “facility census,” “patient census,” and “advanced search.” Healthcare providers and payers prefer to track healthcare provided to patients by facility and/or by patient. The advanced search menu provides a more detailed search method to drill down into the stored healthcare information for specific information.

The search menu title 304 generally identifies the particular search menu with time and date information (e.g., “Patient Census (Wed Mar. 5 23:49:36 EST 2003). The exact date and time provide desirable information because the healthcare information changes in real time.

The facility menu 305 organizes the patient census by facility. Various facilities may be included and excluded from the search by checking and not checking, respectively, a corresponding box located next to the particular facility's name.

The member identification log on box 306 provides a place where a user can search a particular patient by the patient's member identification (i.e., “member ID).

The help and logoff items 307 permit a user to obtain help in using the ICM application and to logoff the ICM application.

The patient census information 308 generally includes a table having rows and columns that organize healthcare information for multiple patients. The column headings include a patient's member ID#, a patient's name, a patient's gender, a patient's age, a patient's admission date, a patient's facility, and a patient's diagnosis. Other healthcare information related to a patient may be included in the user interface 300, as required or desired.

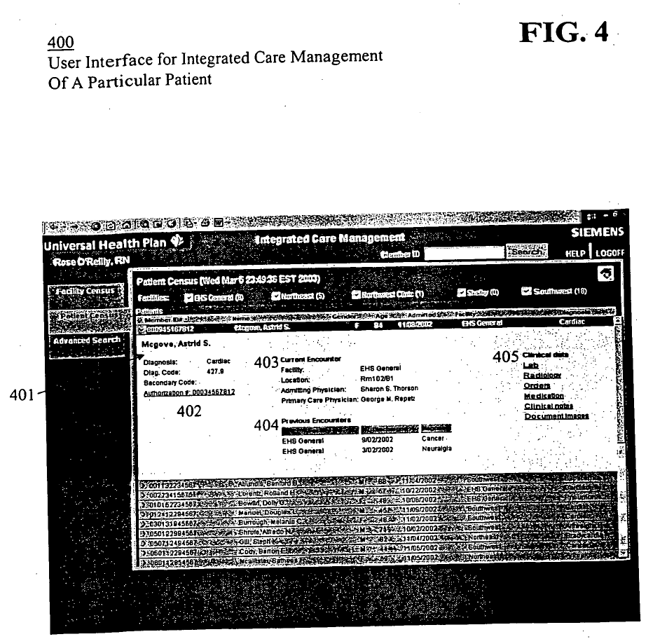

FIG. 4 illustrates a user interface 400 for the integrated care management of a particular patient in the information exchange system 100, as shown in FIG. 1, in accordance with a preferred embodiment of the present invention. In the user interface 400, a case manager for a payer selects a particular patient they would like to review to provide an expanded view of the patient information. In this expanded view, the case manager may review additional patient detail and access a real-time snap shot of clinical data from various provider systems by choosing one of the links displayed in the “clinical data” area 405.

In particular, the user interface 400 includes a patient's name 401, a patient's diagnosis 402, information related to a patient's current encounter with a facility 403, information relating to a patient's previous encounters with one or more facilities 404, clinical data 405 related to a patient's current and/or previous treatments. Preferably, the healthcare information is provided for a particular patient (e.g., “McGrove, Astrid S.”) by double clicking on a row or arrow in front of the row having the patient's name in FIG. 3. Note that the patient information in the row in FIG. 3 remains in FIG. 4 above the particular patient information for the user's reference. Other content and/or formats may be used, as required or desired.

The patient's diagnosis 402 includes, without limitation, diagnosis name, code, and authorization number. The information related to a patient's current encounter with a facility 403 includes, without limitation, a facility name, a room number, admitting physician, and primary care physician. The information relating to a patient's previous encounters with one or more facilities 404 includes, without limitation, the facility's name and corresponding date of discharge and corresponding diagnosis. The clinical data 405 includes, without limitation, lab information, radiology information, physician orders, medication, clinical notes, and document images.

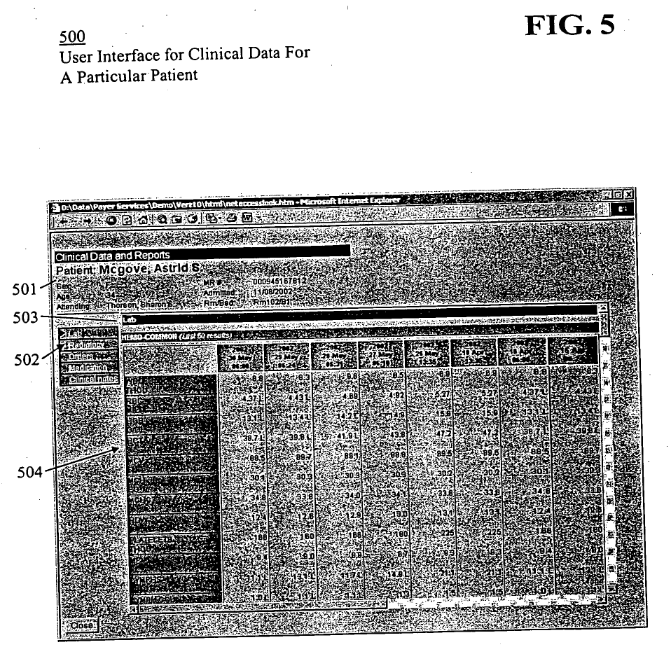

FIG. 5 illustrates a user interface 500 for integrated care management of clinical data for a particular patient in the information exchange system 100, as shown in FIG. 1, in accordance with a preferred embodiment of the present invention. The user interface 500 appears responsive to a selection of a link from the clinical data area 405 in the user interface 400 shown in FIG. 4. Preferably, the user is securely authenticated and provided “view only access” into the provider's clinical access information. Preferably, the user interface 500 a user to review the information relative to a user member's current inpatient stay. Preferably, each link, as shown in FIG. 4, provides secure “view only access” to information generated by each provider's respective clinical system.

In particular, the user interface 500 includes a patient's name and identifying information 501, a clinical data menu 502, a clinical data title bar 503, and detailed clinical data 504. Preferably, the clinical data and reports are provided for a particular patient (e.g., “McGrove, Astrid S.”) by double clicking on the one of the clinical data categories shown in FIG. 4. Other content and/or formats may be used, as required or desired.

The patient's name and identifying information 501 includes, without limitation, the patient's gender, age, attending physician, member ID number, admission date, and room/bed number. The clinical data menu 502 includes, without limitation, lab information, radiology information, physician orders, medication, and clinical notes. The clinical data title bar 503 includes, the name of the clinical data are being reported (e.g., “Lab”). The detailed clinical data 504 includes, without limitation, any type of healthcare information, such as, for example, blood test results, as shown in FIG. 5.

In summary of the preferred embodiment of the present invention, the system 100 provides access by healthcare payer organization personnel to information maintained by a healthcare provider organization. The acquisition processor 116 acquires and collates 203 information from one or more healthcare provider organization information systems 101 including: patient medical eligibility determination related information; patient admission, discharge, and transfer related information; and patient clinical information. The authentication processor 116 verifies 204 that a healthcare payer organization user is authorized to access the acquired collated patient information in response to user entered identification data. A user interface generator 135 provides data representing a display image 300, 400, 500 including elements of the acquired and collated information to an authorized user in response to user command.

Preferably, the acquired and collated information includes, one or more of: an image representative data associated with a patient record, patient demographic information, a patient census list, and patient record scanned documents.

Preferably, the user interface generator 135 provides data representing a display image including user selected combinations of the patient medical eligibility determination related information, the patient admission, discharge, and transfer related information, and the patient clinical information.

Preferably, the acquired and collated information including patient medical eligibility determination related information, patient admission, discharge and transfer related information, and patient clinical information is derived from one or more of: multiple different locations, multiple different healthcare provider organizations, and multiple different computerized information systems 101.

Preferably, the healthcare payer organization user is provided with real-time access to the acquired and collated information.

The system 100 and the method 200 facilitate real-time access to one or more provider's healthcare information by one or more provider's utilization and/or case management professional in a secure, self-service mode delivered anytime and/or anywhere. The integrated care manager (ICM) is a service, supported by appropriate system infrastructure and software applications, that substantially reduces the administrative costs providers and payers incur when gathering and communicating clinical information about their respective patients. The system 100 and the method 200 enables authorized staff from the payer (e.g., insurer) to securely log-on to a web-based portal preferably managed by a third party and view healthcare information about their members in real time who are currently patients at participating hospitals. The web-based portal advantageously provides single sign on (SSO), authentication, portal administration, and access in patient context. Hence, the system 100 and the method 200 advantageously combine applications, services, and infrastructure to provide a user friendly, efficient, real time, and cost effective healthcare management solution.

The system 100 and the method 200 advantageously links transactions to applications. For example, the system 100 and the method 200 integrate eligibility transactions from a HDX transactional environment, admission-discharge-transfer (ADT) transactions from a provider's patient management system, portal infrastructure from a web-based interface (e.g., “Dashboard”), clinical views from net access, scanned images from document imaging into a highly-secure, self-service application portal that eliminates the need for cumbersome management processes. In particular, the Dashboard provides a web-based portal that accesses an ICM user interface that displays patient or facility census information, transactions, and links to other browser applications, such as clinical results and reports.

Uses of the system 100 and the method 200 include:

a) secure information exchange between one or more payers and one or more providers;

b) self-service concurrent utilization and/or managed care review;

c) revenue cycle enhancement;

d) validate medical necessity of inpatient charges for claim justification;

e) deterrent to claim denial; and

f) exception management.

The system 100 and the method 200 may be used by a payer (e.g., healthcare insurer) that wants to streamline the process of utilization review and/or case management between their organization and the healthcare provider's organization that contract to deliver medical services to the payer's members. The system 100 and the method 200 also may be used by any healthcare provider that wants to streamline the process of utilization review and/or case management between their organization and the payer (e.g., healthcare insurer) for which they have contracted to provide medical services.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A system providing access by healthcare payer organization personnel to information maintained by a healthcare provider organization, comprising:
an acquisition processor for acquiring and collating information from at least one healthcare provider organization information system including,
(a) patient medical eligibility determination related information,
(b) patient admission, discharge and transfer related information, and
(c) patient clinical information;
an authentication processor for verifying a healthcare payer organization user is authorized to access the acquired collated patient information in response to user entered identification data; and
a user interface generator for providing data representing a display image including elements of the acquired and collated information to an authorized user in response to user command.

2. A system according to claim 1, wherein the acquired and collated information includes, at least one of:
(a) image representative data associated with a patient record,
(b) patient demographic information,
(c) a patient census list, and
(d) patient record scanned documents.

3. A system according to claim 1, wherein the user interface generator provides data representing a display image including user selected combinations of information elements (a), (b) and (c).

4. A system according to claim 1, wherein the acquired and collated information includes patient medical eligibility determination related information, patient admission, discharge and transfer related information, and patient clinical information derived from at least one of:
(a) multiple different locations,
(b) multiple different healthcare provider organizations, and
(c) multiple different computerized information systems.

5. A system according to claim 1, wherein the healthcare payer organization user is provided with real-time access to the acquired and collated information.

6. A healthcare management system comprising:
a communication interface permitting communications between a healthcare provider system and the healthcare management system, and permitting communications between a healthcare payer system and the healthcare management system;
an acquisition processor for:
receiving healthcare information from the healthcare provider system via the communication interface, wherein the healthcare information includes case management information for a patient being cared for by a healthcare provider operating the healthcare provider system; and
receiving requests for the healthcare information from the healthcare payer system via the communication interface;
an authentication processor for verifying that:
a user of the healthcare provider system is authorized to send the healthcare information to the healthcare management system responsive to receiving the healthcare information from the healthcare provider system; and
a user of the at least one healthcare payer system is authorized to access the healthcare information responsive to receiving the requests for the healthcare information from the healthcare payer system; and
a memory device for storing the healthcare information responsive to verifying that the user of the healthcare provider system is authorized to send the healthcare information to the healthcare management system; and
a user interface generator for providing data, representing a display image, including elements of the stored healthcare information, to the healthcare payer system responsive to verifying that the user of the healthcare payer system is authorized to access the healthcare information.

7. A healthcare management system according to claim 6, wherein the authentication processor verifies that:
the user of the healthcare provider system is authorized to send the healthcare information responsive to identification data entered by the user of the healthcare provider system; and
the user of the healthcare payer system is authorized to access at least some of the healthcare information responsive to identification data entered by the user of the at least one healthcare payer system.

8. A healthcare management system according to claim 6, wherein the user interface generator provides the data, representing the display image, responsive to a command by the user of the healthcare payer system.

9. A healthcare management system according to claim 6, wherein the user interface generator provides:
a first rejection message to the healthcare provider system via the communication interface responsive to verifying that the user of the healthcare provider system is not authorized to send the healthcare information, and
a second rejection message to the healthcare payer system via the communication interface responsive to verifying that the user of the healthcare payer system is not authorized to access the healthcare information.

10. A healthcare management system according to claim 6,
wherein the memory device stores the requests for the healthcare information from the healthcare payer system, representing healthcare payer activity in the healthcare management system,
wherein the acquisition processor receives requests for the healthcare payer activity from the healthcare provider system via the communication interface,
wherein the authentication processor verifies that:
a user of the healthcare provider system is authorized to access the healthcare payer activity responsive to receiving the requests for the healthcare payer activity from the healthcare provider system, and
wherein the user interface generator provides data, representing the display image, including elements of the stored healthcare payer activity, to the healthcare provider system responsive to verifying that the user of the healthcare provider system is authorized to access the healthcare payer activity.

11. A healthcare management system according to claim 10, wherein the user interface generator provides:
a third rejection message to the healthcare provider system via the communication interface responsive to verifying that the user of the healthcare provider system is not authorized to access the healthcare payer activity.

12. A healthcare management system according to claim 6, wherein the case management information further comprises:
(a) patient medical eligibility determination related information,
(b) patient admission, discharge and transfer related information, and
(c) patient clinical information.

13. A healthcare management system according to claim 12, wherein the user interface generator provides data, representing the display image, including user selected combinations of the case management information (a), (b) and (c).

14. A healthcare management system according to claim 6, wherein the case management information further comprises:
the acquired and collated information includes, at least one of, (a) image representative data associated with a patient record, (b) patient demographic information, (c) a patient census list and (d) patient record scanned documents.

15. A healthcare management system according to claim 6, wherein the case management information further comprises:
patient medical eligibility determination related information,
patient admission, discharge and transfer related information, and
patient clinical information derived from at least one of:
(a) multiple different locations,
(b) multiple different healthcare provider organizations, and
(c) multiple different computerized information systems.

16. A healthcare management system according to claim 6, wherein the user of the healthcare payer system is provided with real-time access to the case management information.

17. A method for managing healthcare information comprising the steps of:
receiving healthcare information from healthcare provider system, wherein the healthcare information includes case management information for a patient being cared for by a healthcare provider operating the healthcare provider system;
verifying that a user of the healthcare provider system is authorized to send the healthcare information responsive to receiving the healthcare information from the healthcare provider system;
storing the healthcare information responsive to verifying that the user of the healthcare provider system is authorized to send the healthcare information;
receiving requests for the healthcare information from healthcare payer system;
verifying that a user of the healthcare payer system is authorized to access the healthcare information responsive to receiving the requests for the healthcare information from the healthcare payer system; and
providing data, representing a display image, including elements of the stored healthcare information, to the healthcare payer system responsive to verifying that the user of the healthcare payer system is authorized to access the healthcare information.

18. A method for managing healthcare information according to claim 17 further comprising the steps of:
providing a first rejection message to the healthcare provider system responsive to verifying that the user of the healthcare provider system is not authorized to send the healthcare information, and
providing a second rejection message to the healthcare payer system responsive to verifying that the user of the healthcare payer system is not authorized to access the healthcare information.

19. A method for managing healthcare information according to claim 17 further comprising the steps of:
storing the requests for the healthcare information from the healthcare payer system representing healthcare payer activity in the healthcare management system,
receiving requests for the healthcare payer activity from the healthcare provider system,
verifying that a user of the healthcare provider system is authorized to access the healthcare payer activity responsive to receiving the requests for the healthcare payer activity from the healthcare provider system, and
providing data, representing the display image, including elements of the stored healthcare payer activity, to the healthcare provider system responsive to verifying that the user of the healthcare provider system is authorized to access the healthcare payer activity.

20. A method for managing healthcare information according to claim 19 further comprising the steps of:
providing a third rejection message to the healthcare provider system responsive to verifying that the user of the healthcare provider system is not authorized to access the healthcare payer activity.
